(19) United States
(12) Patent Application Publication
(10) Pub. No.: US 2006/0126801 A1
(43) Pub. Date: Jun. 15, 2006

(54) Trouble ticket monitoring system having internet enabled and web-based graphical user interface to trouble ticket workload management systems

(75) Inventors: Erian Laperi, Wentzville, MO (US); Jeremy A. Dilks, East Alton, IL (US)

Correspondence Address: BROOKS KUSHMAN P.C., 1000 TOWN CENTER, TWENTY-SECOND FLOOR, SOUTHFIELD, MI, 48075, US

(73) Assignee: SBC Knowledge Ventures, L.P., Reno, NV (US)

(21) Appl. No.: 11/011,682

(22) Filed: Dec. 14, 2004

(51) Int. Cl. H04M 3/08

(52) U.S. Cl. 379/32.01

(57) ABSTRACT

A trouble ticket monitoring system includes an Internet enabled and Web-based graphical user interface (GUI) to trouble ticket workload management systems such as legacy WFAC, WFADO, and WFADI systems. A dashboard application implements the GUI to essentially enable everything that can be done on WFA systems to be able to be done using the GUI. The dashboard application interacts with legacy WFA systems for both trouble ticket reporting and interactive trouble ticket functions while presenting a simple user interface. Point and click functionality provided by the dashboard application for users allows for reporting or maintenance functions to be performed with a minium of typing or knowledge of the WFA systems. The dashboard application is a server based rather than client based approach to trouble ticketing generation and monitoring. The dashboard application combines reports and queries from the WFA systems to present an overview of all maintenance operations in one location.

### BACKGROUND OF THE INVENTION

1. Field of the Invention

The present invention generally relates to management systems for monitoring trouble tickets in a telecommunications services environment. More particularly, the present invention relates to a trouble ticket monitoring system having an Internet enabled and Web-based remote graphical user interface (GUI) to trouble ticket workload management systems.

2. Background Art

In order to ensure a high availability rate in communications network services provided to customers, service providers require accurate and responsive maintenance efforts. Workload management systems that support these maintenance efforts are a vital part of a service provider's marketability.

Workload management systems such as Work and Force Administration—Control (WFAC), Work and Force Administration—Dispatch Out (WFADO), and Work and Force Administration—Dispatch In (WFADI) are trouble ticket reporting and tracking software systems used by service providers to monitor workload and individual trouble ticket history. Such workload management systems (collectively referred to as “WFA systems”) are fault management tools which allow a trouble ticket to be opened in response to a telecommunications network fault or a service problem.

Service providers use trouble ticketing as a means for identifying reported network faults or service problems. When a network fault or service problem is reported, a trouble ticket describing the network fault or service problem is opened in one or more of the WFA systems. Generically, WFA systems are databases and trouble tickets are electronic tracking mechanisms that exist as data records in at least one of these databases.

In operation, the status of a trouble ticket is considered open as long as the network condition remains unresolved. At any given time, the collection of open trouble tickets represents the set of ongoing and future repair efforts of the service provider. This mechanism provides the service provider with a method for identifying the status of current and future repair efforts.

The problem with WFA systems is that they lack an Internet enabled and Web-based remote interface that enables different users to open and monitor trouble tickets relating to network faults and service problems on the enterprise network. Further, WFA systems are not universally provided with an interface to communicate and transfer information to other systems.

As such, the trouble ticket reports generated by WFA systems are not interactive. That is, the generated trouble ticket reports are listings of trouble tickets which are not easily organized or displayed in a convenient way for personnel of the service provider. Further, WFA systems require users to enter typed commands to open trouble tickets and to generate more specific trouble ticket reports.

In a system employing more than one WFA system, service provider personnel are required to enter typed search criteria in each WFA system in order to obtain a listing of trouble tickets satisfying a certain criteria. The service provider personnel then have to manually correlate the generated trouble ticket listings using a spreadsheet in order to identify the trouble tickets satisfying all of the search criteria.

### BRIEF DESCRIPTION OF THE DRAWINGS

FIG. 1 illustrates a block diagram of a trouble ticket monitoring system in accordance with an embodiment of the present invention;

FIG. 2 illustrates a flow chart showing basic operations carried out by the trouble ticket monitoring system for enabling users to generate and update trouble tickets for storage in trouble ticket workload management systems;

FIG. 3 illustrates a flow chart showing basic operations carried out by the trouble ticket monitoring system for enabling users to receive tailored displays of trouble ticket reports;

FIG. 4 illustrates a flow chart showing basic operations carried out by the trouble ticket monitoring system for alerting users to escalation trouble ticket information;

FIGS. 5 through 20 illustrate representative graphical user interfaces (GUIs) generated by the dashboard application of the trouble ticket monitoring system; and

FIG. 21 illustrates an example of an OQS report.

### DETAILED DESCRIPTION OF THE PREFERRED EMBODIMENT(S)

The advantages of a trouble ticket monitoring system in accordance with the present invention are numerous. In general, the trouble ticket monitoring system has an Internet enabled and Web-based graphical user interface (GUI) to trouble ticket workload management systems. Such workload management systems include legacy WFAC, WFADO, and WFADI systems (collectively referred to as “WFA systems”).

The trouble ticket monitoring system includes a dashboard application. In general, the dashboard application enables everything that can be done on WFA systems to be able to be done using an Internet enabled Web-based GUI. As such, the dashboard application represents a server based rather than client based approach to trouble ticketing generation and monitoring. The dashboard application provides a GUI for point and click navigation, functions, and commands to the WFA systems. The dashboard application provides ease of customization, updates, and upgrades to meet service provider and customer needs to WFA systems. The dashboard application is able to combine reports and queries from several different WFA systems into one meaningful display.

In operation, the dashboard application combines both real-time and historical data from several sources (including different WFA systems) to present an overview of all maintenance operations in one location. The dashboard application provides drill-down capabilities for trouble ticket reports in order to display the trouble ticket information required by a user at a specific time without requiring manual processing or knowledge of the legacy WFA systems on the user's part. The dashboard application also provides interaction with legacy WFA systems and embedded testing applications to allow many necessary maintenance functions to be performed from one application or one interface.

In general, the dashboard application interacts with legacy WFA systems for both trouble ticket reporting and interactive trouble ticket functions while presenting a simple user interface. Point and click functionality provided by the dashboard application for users allows for reporting or maintenance functions to be performed with a minium of typing or knowledge of the legacy WFA systems.

The dashboard application also interacts with a Symposium Call Center system to provide reports of the center's call center functions. The dashboard application facilitates access to embedded testing systems such as the ASI Circuit Manager, Broadband Tools, and the SBCIS ATM Ping Tool. This allows for a more efficient method of pulling information concerning circuit performance without having to switch between applications and request such information manually.

The dashboard application has built-in escalation ability to allow service provider management to set criteria for trouble ticket report handling and be notified when these criteria are not met. Notifications of missed criteria retain the ability of testing and performing maintenance functions to allow efficient addressing of these reports.

The dashboard application uses historical data to aid in spotting trends and to predict future workload. The dashboard application presents such trends as both raw data and in graphical format. The dashboard application is implemented with the ability to use historical data to predict workload for the day from current data and to forecast the necessary amount of work to address incoming workload.

The dashboard application is preferably written in PERL and runs on any Web server installed with PERL and capable of running CGI scripts. As such, no specific client-side applications are required other than standard Web browser software. The dashboard application therefore can be used on almost any personal computer (PC) out-of-the box.

With the dashboard application running all of the functions on the server side, updates and maintenance are simplified. Once updates or changes have been made on the server side using the dashboard application all clients (i.e., the legacy WFA systems, the embedded test systems, etc.) receive the new information the next time any action is performed. No beta-testing is required for updates and enhancements to ensure compatibility with the multiple clients now in use as long as HTTP compliant code is presented to the end user. Necessary PERL modules are either available with any PERL distribution or can be created specifically for the dashboard application.

The dashboard application can also be modified for new trouble ticket reporting formats as long as the trouble ticket reports are available via a TCP/IP network. Similarly, any new applications will also be supported if they are capable of TCP/IP communication. Security is provided via encryption where necessary, for instance when user information such as passwords are communicated.

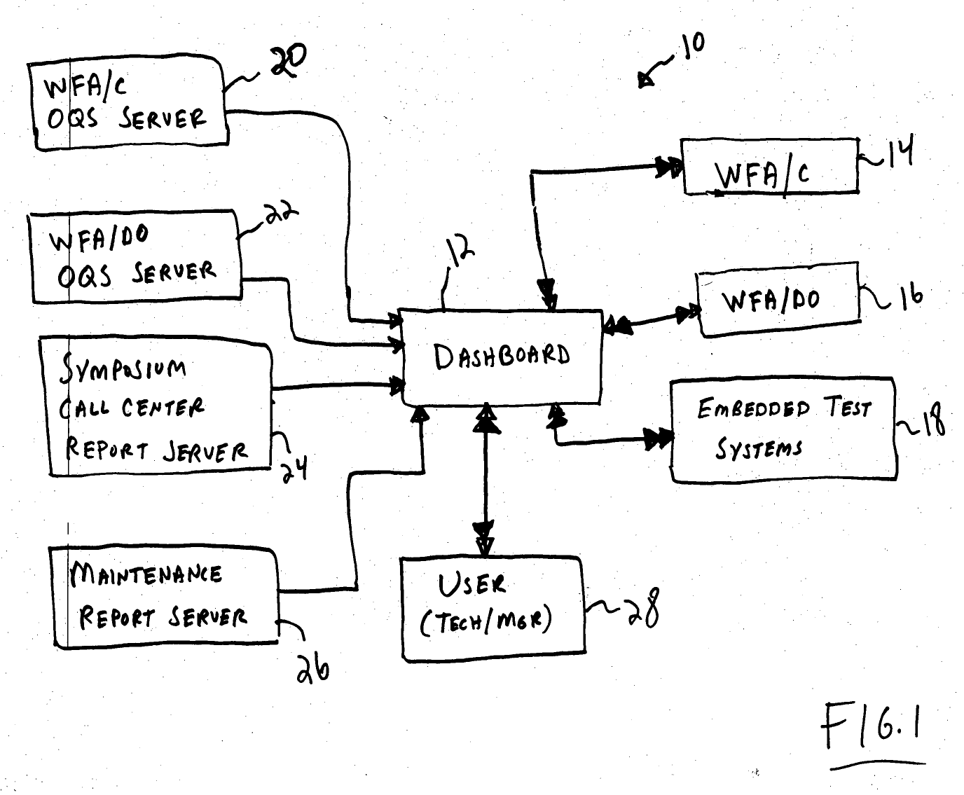

Referring now to FIG. 1, a block diagram of a trouble ticket monitoring system 10 in accordance with an embodiment of the present invention is shown. Trouble ticket monitoring system 10 includes a dashboard application 12. Dashboard application 12 is a software application operating on a personal computer. Dashboard application 12 is an Internet enabled and Web-based graphical user interface (GUI) which interfaces with trouble ticket workload management systems such as WFAC 14 and WFADO 16 and embedded testing systems 18. (Dashboard application 12 also interfaces with a WFADI system (not shown).)

Connections between dashboard application 12 and the multiple WFA hosts 14, 16 and embedded testing systems 18 are provided by TCP/IP sockets. Dashboard application 12 provides an interface wherein a user 28 may login and use a single password to access the multiple WFA hosts 14, 16 and embedded testing systems 18 with no need to login and enter a password for each of these systems. As denoted by the double arrows, dashboard application 12 supports simultaneous sessions with the multiple WFA hosts 14, 16, multiple users 28, and embedded testing systems 18.

Dashboard application 12 also interfaces with a WFAC Online Query System (OQS) server 20, a WFADO OQS server 22, a symposium call center report server 24, and an ASI maintenance report server 26. (Dashboard application 12 also interfaces with a WFADI OQS server (not shown).)

As noted above, dashboard application 12 provides an Internet enabled Web-based GUI which provides a mechanism to transfer data among the various systems and servers connected to the dashboard application. As a result, data may be quickly and easily accessed by user 28 to speed the process by which trouble ticket reports are resolved.

The popularity and wide spread adoption of the Internet provides a measure of platform independence for users 28 who wish to connect to enterprise systems such as WFA systems and embedded testing systems, as the users can run their own Internet Web browser and use their own platform connection to the Internet to enable service. This resolves many of platform hardware and connectivity issues in favor of users 28, and lets the users choose their own workstation platform and operating system. Web-based programs minimize the need for training and support as they use existing user browser software which users 28 have already installed and know how to use. Any issues relating to connectivity and communications have already been resolved in favor of standard and readily available hardware and the browser and dial-up software used by the Internet connection.

An Internet delivered paradigm for WFA services obviates many of the installation and configuration problems involved with initial setup and configuration of a dial-up user workstation, as dashboard application 12 required to interface with the legacy WFA systems can be delivered to users 28 via the Internet and run within a standard Web browser, reducing compatibility issues of the dashboard application to browser compatibility issues.

In general, in order to generate trouble tickets for storage in at least one of WFA systems 14, 16, dashboard application 12 provides a GUI for users 28 to use in order to generate trouble tickets. This GUI provided by dashboard application 12 has a structured format for receiving trouble ticket information from users 28. As such, dashboard application 12 acts as a filter to ensure that proper information for generating trouble tickets is inputted by users 28. In turn, dashboard application 12 provides the trouble tickets to at least one of WFA systems 14, 16.

As indicated above, WFA systems 14, 16 are trouble ticket and reporting systems which store trouble tickets. As the trouble tickets are worked on and resolved, users 28 use another GUI provided by dashboard application 12 to update in WFA systems 14, 16 the status of the trouble tickets and remove trouble tickets from the WFA systems which have been resolved.

In general, in order to provide trouble ticket reports, dashboard application 12 receives data indicative of the trouble tickets stored in WFA systems 14, 16 from WFA OQS servers 20, 22. Dashboard application 12 provides GUIs of the trouble ticket reports for display to users 28. Users 28 use the GUIs to have dashboard application 12 manipulate the data received from WFA OQS servers 20, 22 in order to generate tailored GUI trouble tickets report for display to the users.

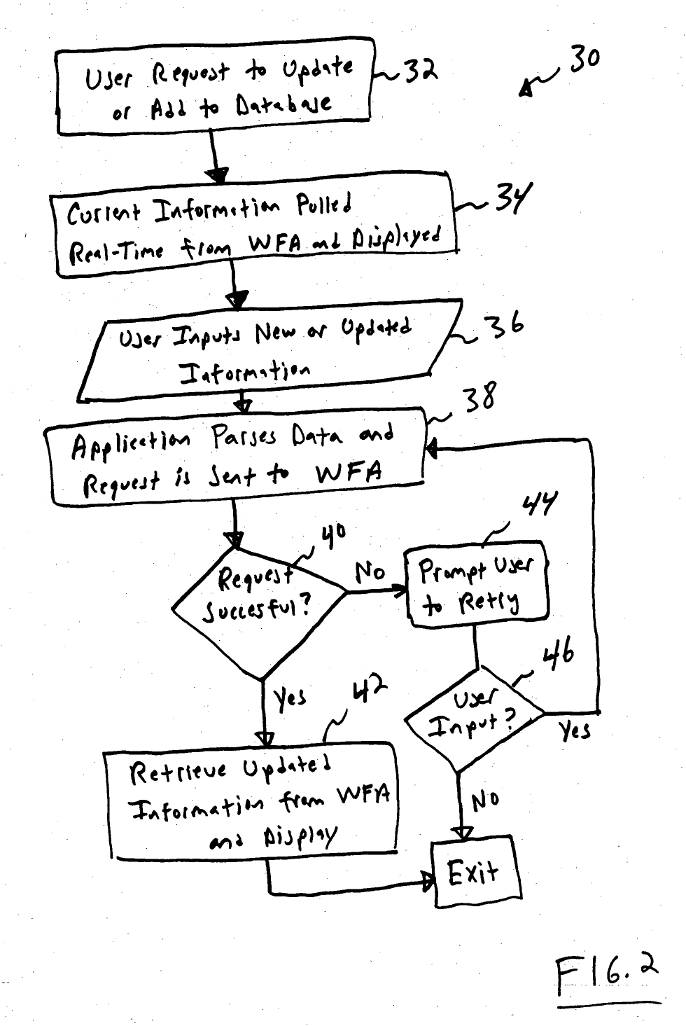

Referring now to FIG. 2, with continual reference to FIG. 1, a flow chart 30 showing basic operations carried out by trouble ticket monitoring system 10 for enabling users 28 to generate and update trouble tickets for storage in trouble ticket workload management systems 14, 16 is shown. In general, flow chart 30 represents the WFA functions provided by trouble ticket monitoring system 10.

In operation, dashboard application 12 receives a request from a user 28 for updating a trouble ticket or adding a trouble ticket in WFA systems 14, 16 as shown in block 32. To this end, dashboard application 12 displays for user 28 a GUI which has a standard format for updating or adding a trouble ticket. User 28 uses this GUI to transmit to dashboard application 12 the updated or added trouble ticket information. In turn, dashboard application 12 pulls current information regarding the updated or added trouble ticket from WFA systems 14, 16 and displays same in a GUI to user 28 as shown in block 34.

User 28 then uses this GUI to input updated or new trouble ticket information as shown in block 36. Dashboard application 12 then parses the inputted updated or new trouble ticket information and sends an appropriate request to WFA systems 14, 16 as shown in block 38. Dashboard application 12 receives a message from WFA systems 14, 16 regarding whether the request is successful as shown in block 40. If the request is successful, meaning that WFA systems 14, 16 have received from dashboard application 12 the updated or new trouble ticket information, then the dashboard application retrieves the updated trouble ticket information from the WFA systems as shown in block 42. In turn, dashboard application 12 displays in a GUI the retrieved updated trouble ticket information for user 28 as shown in block 42.

If the request is unsuccessful, meaning that WFA systems 14, 16 have not received from dashboard application 12 the updated or new trouble ticket information for some reason (such as the request being improper, not consistent with trouble tickets stored in the WFA systems, in an incorrect format, etc.), then the dashboard application prompts user 28 with another GUI to retry the request as shown in block 44. If user 28 uses this GUI to successfully input updated or new trouble ticket information as shown in block 46, dashboard application 12 then repeats operation steps 38, 40, and 42.

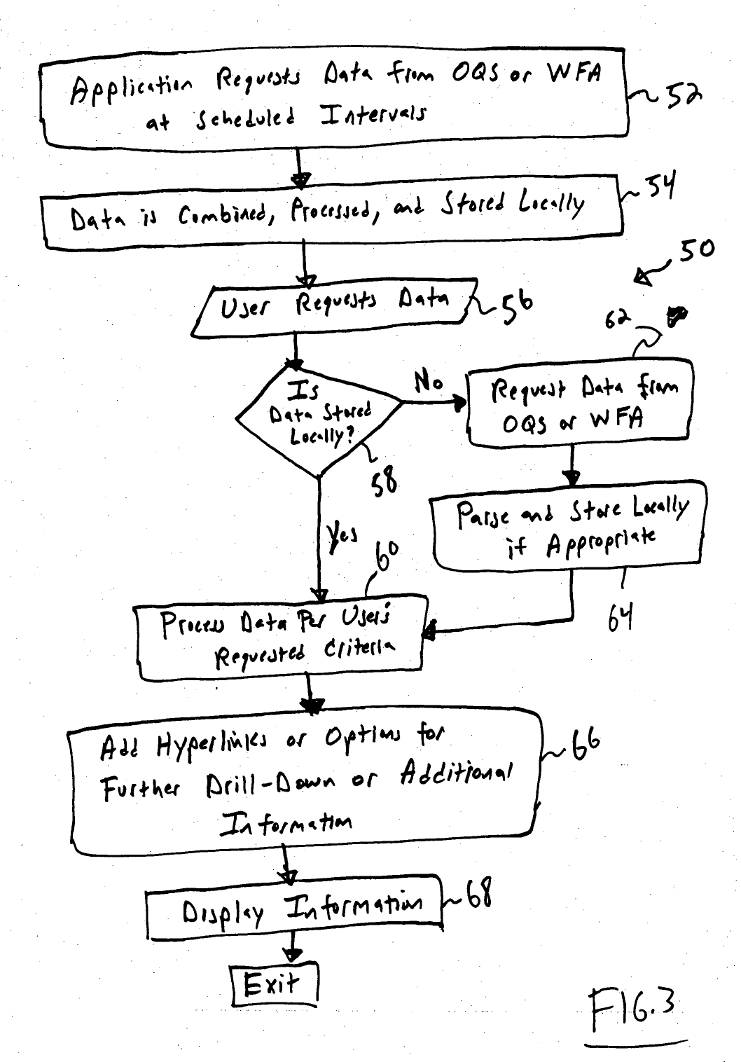

Referring now to FIG. 3, with continual reference to FIG. 1, a flow chart 50 showing basic operations carried out by trouble ticket monitoring system 10 for enabling users 28 to receive tailored displays of trouble ticket reports is shown. In general, flow chart 50 represents the real-time/historical reporting functions of trouble ticket monitoring system.

In operation, dashboard application 12 periodically receives trouble ticket data from WFA OQS servers 20, 22 as shown in block 52. The trouble ticket data is indicative of the trouble tickets stored in WFA systems 14, 16 at a current time. Dashboard application 12 automatically receives the data without human intervention from WFA OQS servers 20, 22 every half hour or so. As such, in this example, dashboard application actually receives two sets of trouble ticket data. One set of trouble ticket data is the trouble ticket information from WFA system 14 and the other set of trouble ticket data is the trouble ticket information from WFA system 16. As indicated above, there may be other WFA systems such as a WFADI system which would also have its own set of trouble ticket information.

Upon receiving all of the sets of trouble ticket information, dashboard application 12 combines, processes, and locally stores the trouble ticket information as shown in block 54. Dashboard application 12 displays a GUI for user 28 to use in order for the user to request a trouble ticket report as shown in block 56. This GUI enables user 28 to enter trouble ticket search criteria for generating a tailored trouble ticket report. Such a tailored trouble ticket report includes the trouble tickets which meet the trouble ticket search criteria of user 28.

Upon receiving a request for a trouble ticket report from user 28, dashboard application 12 determines if the trouble ticket data for the requested trouble ticket report is stored locally by the dashboard application as shown in block 58. If so, dashboard application 12 processes and manipulates the locally stored trouble ticket data per the requested criteria of user 28 to generate the appropriate trouble ticket report as shown in block 60. Again, the appropriate trouble ticket report includes the trouble tickets which meet the requested criteria of user 28.

If dashboard application 12 determines that the trouble ticket data for the requested trouble ticket report is not stored locally, then the dashboard application requests from WFA systems 14, 16 and WFA OQS servers 20, 22 the requested trouble ticket data as shown in block 62. Upon receiving the requested trouble ticket data, dashboard application 12 parses and locally stores the requested trouble ticket data if appropriate as shown in block 64. Dashboard application 12 then processes and manipulates the locally stored trouble ticket data per the requested criteria of user 28 to generate the appropriate trouble ticket report as shown in block 60.

Once dashboard application 12 has generated the appropriate trouble ticket report, the dashboard application adds hyperlinks or options for further drill-down capability of the appropriate trouble ticket report as shown in block 66. The hyperlinks or options added may also be for additional information as shown in block 66. Dashboard application 12 then displays a GUI of the appropriate trouble ticket report along with any added hyperlinks or options for user 28 as shown in block 68.

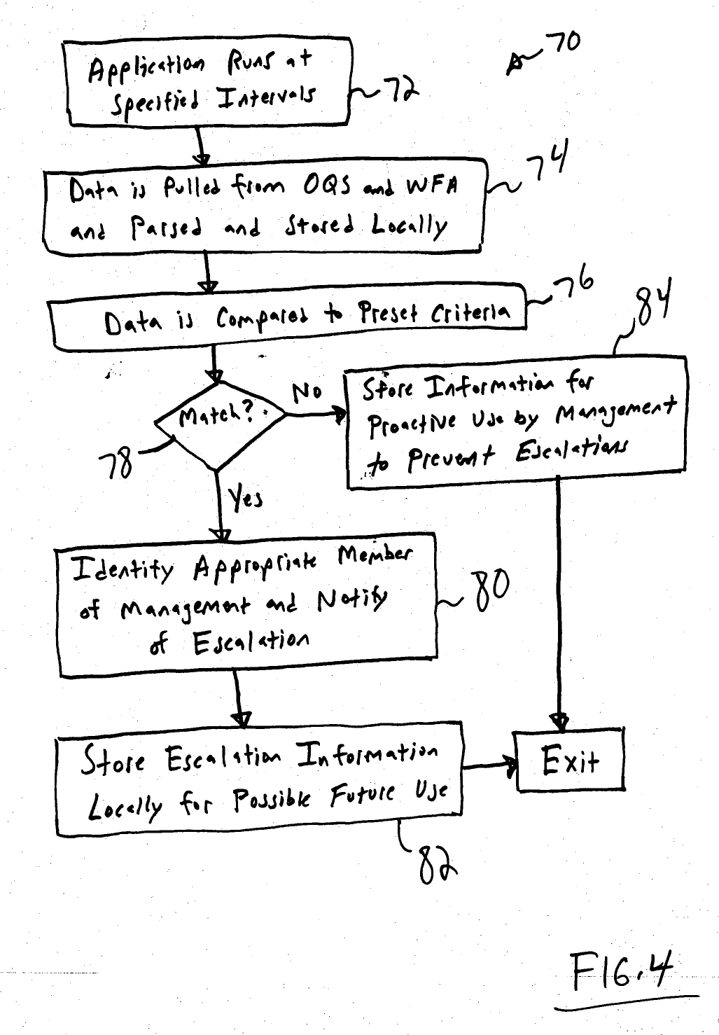

Referring now to FIG. 4, with continual reference to FIGS. 1 and 3, a flow chart 70 showing basic operations carried out by trouble ticket monitoring system 10 for alerting users 28 to escalation trouble ticket information is shown. In general, flow chart 70 represents the local escalations function provided by trouble ticket monitoring system 10.

In operation, dashboard application 12 runs at specified intervals for generating escalation trouble ticket reports as shown in block 72. Dashboard application 12 provides a GUI for display to user 28 for the user to enter trouble ticket escalation criteria. During each interval, dashboard application 12 pulls trouble ticket data from WFA OQS servers 20, 22 as shown in block 74. Dashboard application 12 parses and locally stores the pulled trouble ticket data as shown in block 74.

Dashboard application 12 compares the parsed and locally stored trouble ticket data with the user's preset trouble ticket escalation criteria as shown in block 76 to determine whether there is a match as shown in block 78. If there is a match, meaning there is an trouble ticket escalation event, then dashboard application 12 alerts an appropriate user of the escalation event as shown in block 80. The alert could be in the form of a GUI for display to the appropriate user. Dashboard application 12 then locally stores information regarding the escalation event as shown in block 82. If there is not a match at block 78, then dashboard application 12 stores the information for proactive use by users 28 to prevent escalations as shown in block 84.

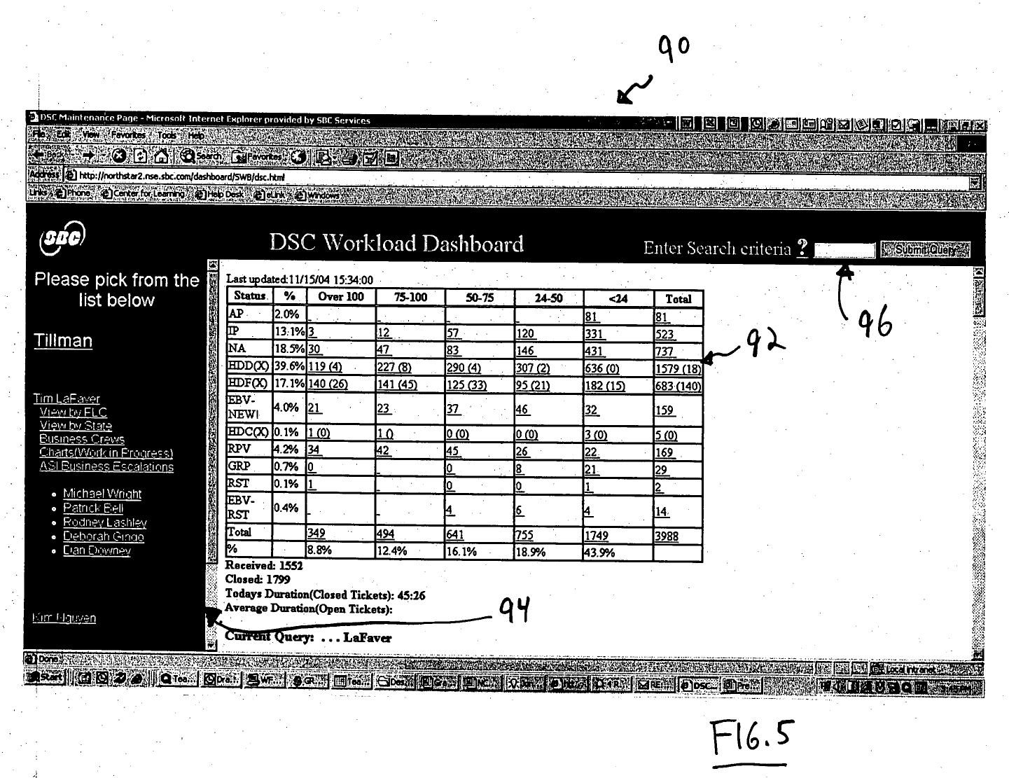

Referring now to FIG. 5, with continual reference to FIGS. 1 and 3, a GUI 90 generated by dashboard application 12 for displaying a trouble ticket report to a user 28 is shown. GUI 90 is an exemplary representation of a main trouble ticket report view. GUI 90 shows all tickets in WFAC system 14 and organizes the trouble tickets by duration horizontally and by ticket status vertically in a table 92. As described above with reference to FIGS. 1 and 3, data representing the trouble tickets stored in WFAC system 14 at a current time is provided to dashboard application 12 via WFAC OQS server 20. WFAC OQS server 20 provides such data as reports in row format. In turn, dashboard application 12 redisplays the trouble ticket information in a meaningful way based on user criteria such as organization/business segmentation, priorities, needs, etc. to generate a trouble ticket report GUI such as GUI 90.

In GUI 90, the hyperlinked (i.e., underlined) numbers within table 92 represent amounts of trouble tickets which have a particular duration and a particular status. As described above, in GUI 90, the trouble tickets are arranged horizontally by duration (such as in minutes since the time the trouble ticket has been opened and unresolved) and arranged vertically by status. The hyperlinked numbers in parentheses represent trouble tickets having expired timers. As will be described in further detail, dashboard application 12 generates other trouble ticket report GUIs in response user 28 clicking on any of the hyperlinked trouble ticket numbers contained in table 92 of GUI 90.

GUI 90 further includes a menu list 94 which allows drill-down capabilities of the trouble ticket reports by trouble ticket segmentation (business, residential) any by management level all the way to retrieving trouble ticket load for individual technicians. GUI 90 further includes a search criteria box 96 which allows a user 28 to enter an instant trouble ticket query by trouble ticket number.

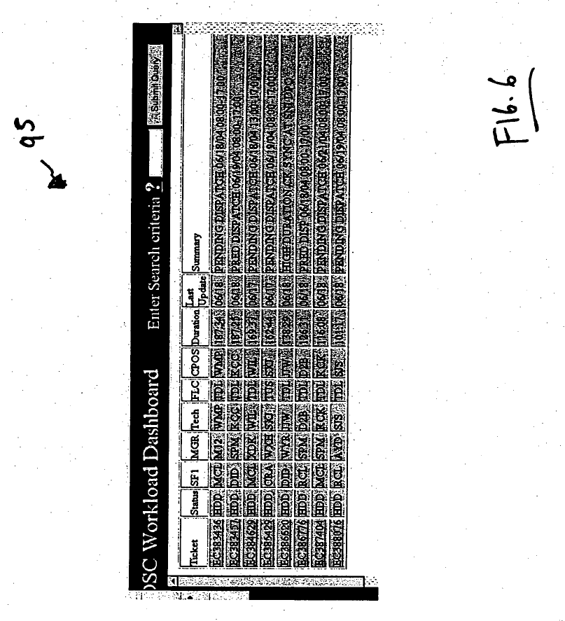

Referring now to FIG. 6, with continual reference to FIG. 5, a GUI 95 generated by dashboard application for displaying drilled-down trouble ticket detail information is shown. Dashboard application 12 generates GUI 95 in response to a user 28 clicking on an associated hyperlinked trouble ticket number in GUI 90. GUI 95 includes a listing of the individual trouble tickets associated with the clicked hyperlinked trouble ticket number of GUI 90.

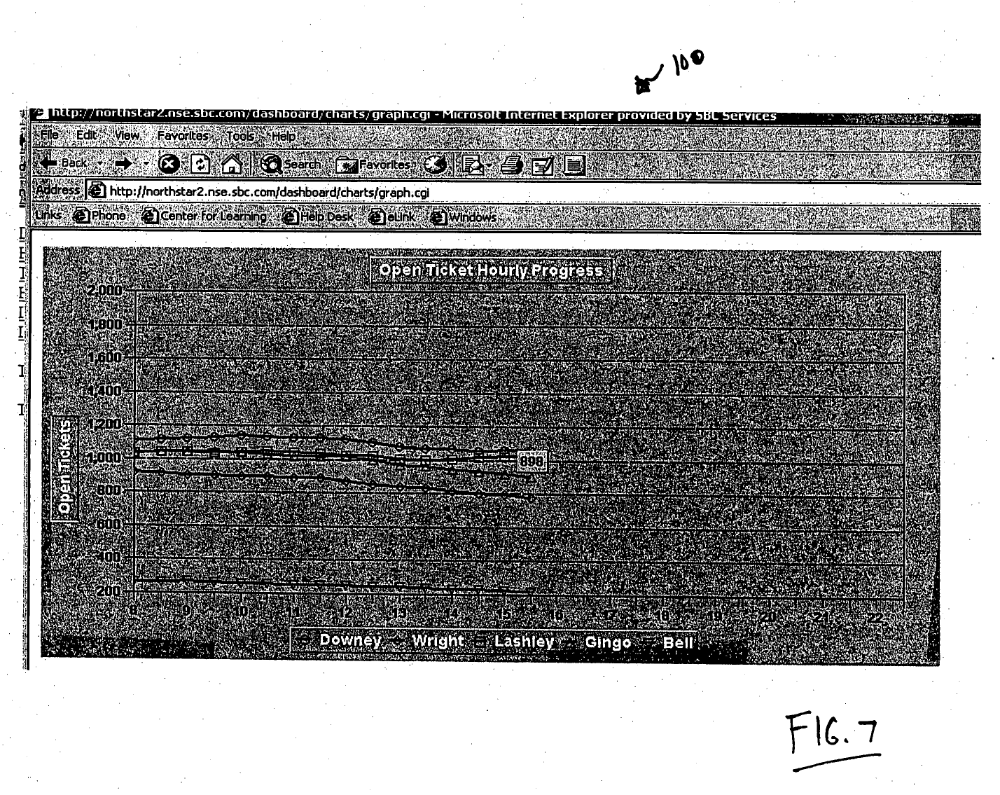

Referring now to FIG. 7, with continual reference to FIG. 5, a GUI 100 generated by dashboard application 12 for displaying open trouble ticket hourly progress information to a user 28 is shown. Dashboard application 12 generates GUIs such as GUI 100 to represent data (trouble ticket volume, call volumes, etc.) in graphical format. As such, GUI 100 has seventeen levels of drill-down ability.

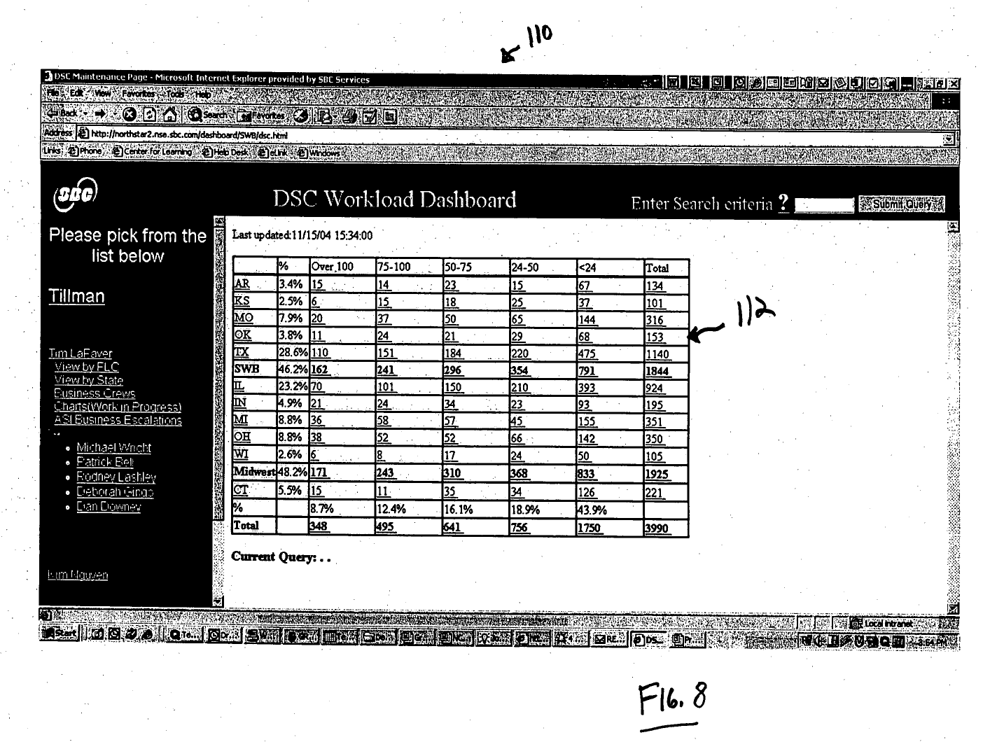

Referring now to FIG. 8, with continual reference to FIG. 5, a GUI 110 generated by dashboard application 12 for displaying trouble ticket information to a user 28 by states and regions is shown. GUI 110 displays a table 112 of trouble ticket information. Table 112 includes hyperlinked numbers representing the overall business trouble ticket load by state and region. For each state and region, table 112 includes horizontally arranged hyperlinked numbers which represent the duration of the trouble tickets associated with the particular state or region. Table 112 further represents the states and regions by hyperlinked abbreviations. In response to a user 28 clicking on a state or region abbreviation, dashboard application 12 generates for display a GUI similar to GUI 90 for the selected state or region. This GUI includes trouble ticket status and duration information for the selected state or region. As such, this GUI is “drilled-down” from GUI 90 and this GUI is a subset of the trouble ticket information shown in GUI 90.

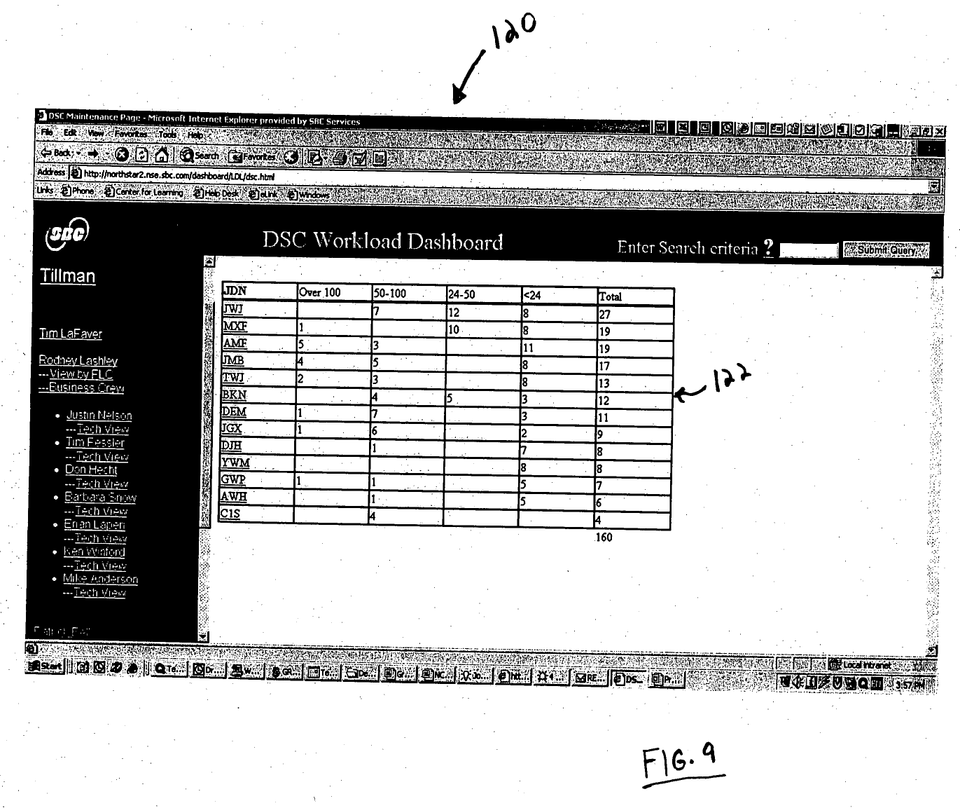

Referring now to FIG. 9, with continual reference to FIG. 5, a GUI 120 generated by dashboard application 12 for displaying trouble ticket information to a user 28 is shown. GUI 120 includes a table 122 which is arranged vertically by technician and horizontally by trouble ticket duration. GUI 120, which represents a technician drill-down trouble ticket report, is generated by dashboard application 12 in response to a user 28 clicking on an appropriate hyperlink in menu list 94 of GUI 90.

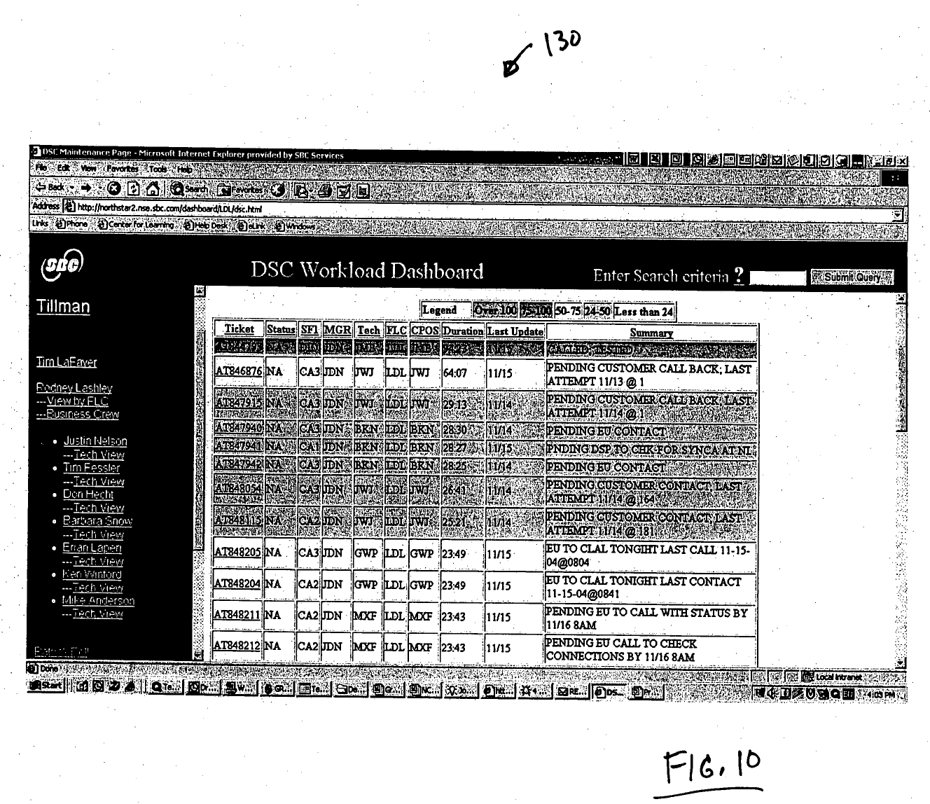

Referring now to FIG. 10, with continual reference to FIG. 5, a GUI 130 generated by dashboard application 12 for displaying individual trouble tickets arranged by duration is shown. Dashboard application 12 generates GUI 130 in response to a user 28 clicking on an appropriate hyperlink in menu list 94 of GUI 90. GUI 130 displays individual trouble tickets in a list arranged by duration from top to bottom. Each individual trouble ticket listed in GUI 130 includes horizontally arranged information such as ticket number, technician responsible for the trouble ticket, duration, summary remarks, etc.

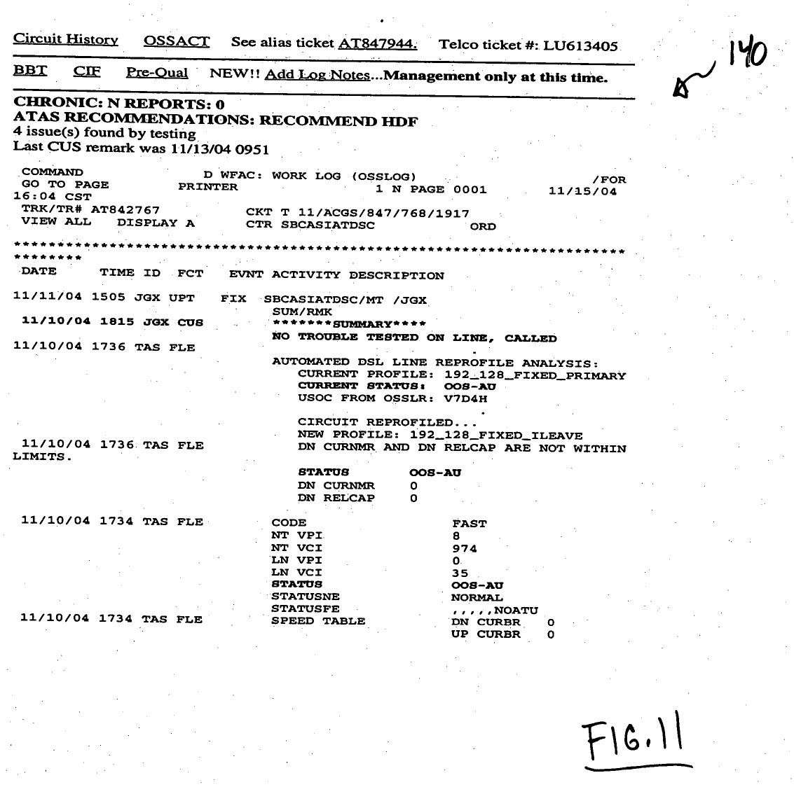

Referring now to FIG. 11, with continual reference to FIG. 5, a GUI 140 generated by dashboard application 12 for displaying an individual ticket is shown. Dashboard application 12 generates GUI 140 in response to a user 28 clicking on an individual trouble ticket from a GUI such as GUI 130. GUI 140 highlights in red testing failures and in blue customer remarks. On top of GUI 140 is a summary of testing recommendations, history of trouble ticket, activity on the trouble ticket and other links and testing tools combined under one point-and-click view.

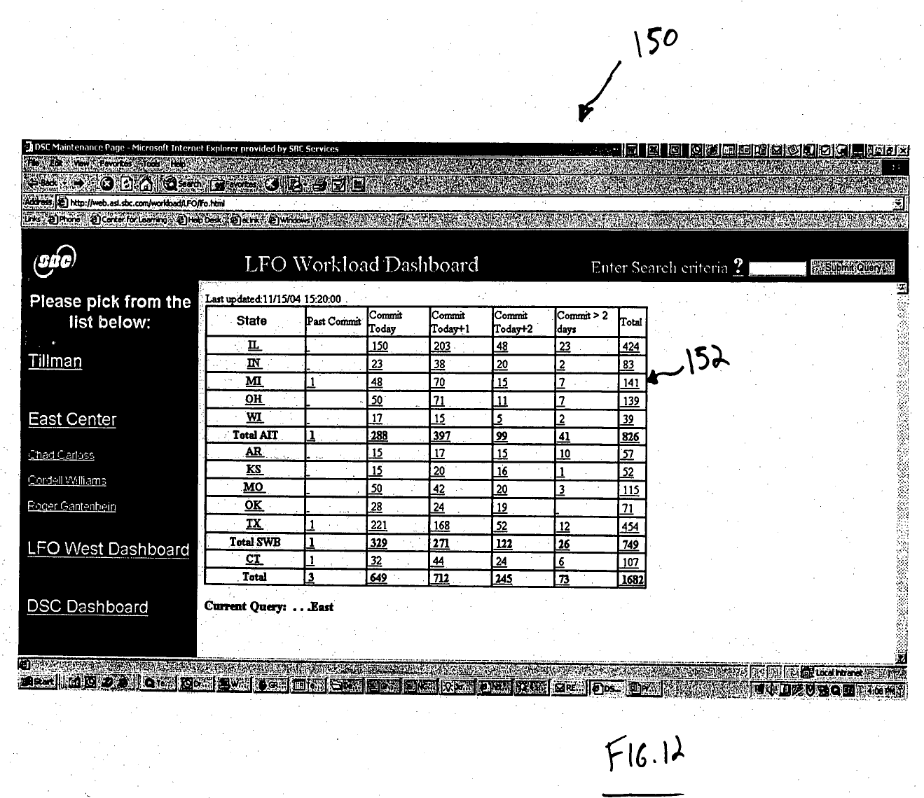

Referring now to FIG. 12, with continual reference to FIG. 5, a GUI 150 generated by dashboard application 12 for displaying a local field operations (LFO) trouble ticket report view (i.e., a WFADO view) is shown. GUI 150 represents a main WFADO trouble ticket report view. GUI 150 includes a table 152 having states and regions arranged vertically and pending trouble tickets by customer commitment due dates arranged horizontally. Again, dashboard application 12 has drill-down capability by technician manager and state and region in order to generates further detailed GUIs based on GUI 150.

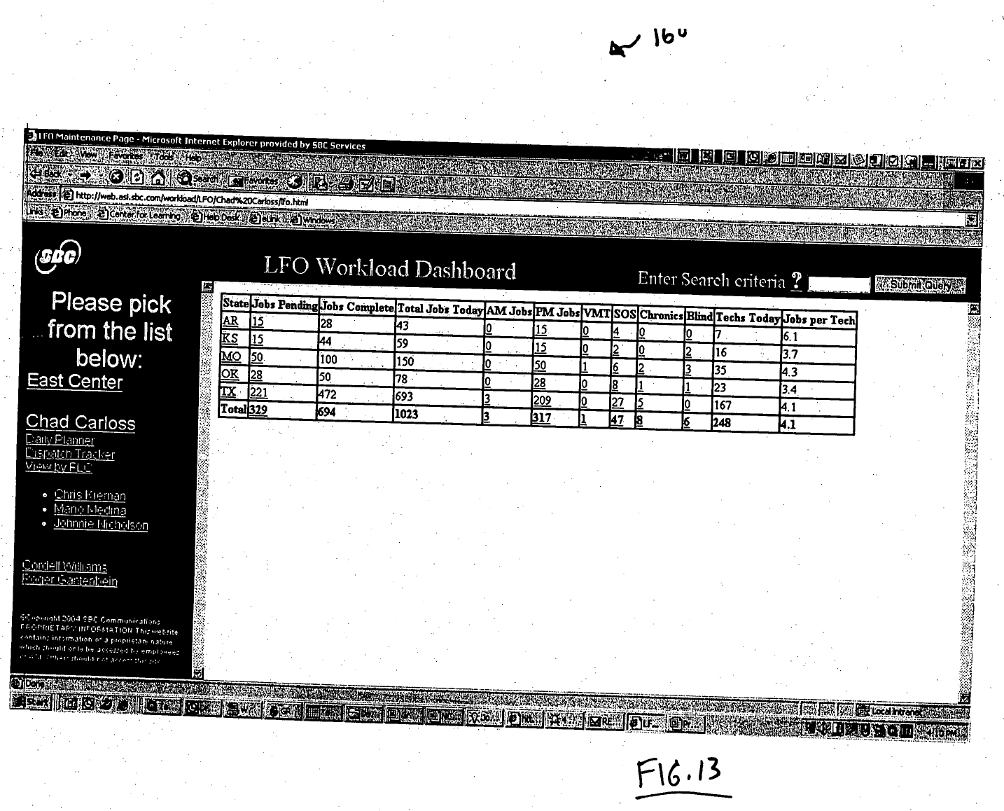

Referring now to FIG. 13, with continual reference to FIG. 12, a GUI 160 generated by dashboard application 12 for displaying to a user 28 an LFO daily planner trouble ticket report is shown. GUI 160 represents a daily planner which shows load volume summary and load to workforce statistics. In order to generate GUI 160, dashboard application 12 combines several separate IMS OQS reports into one meaningful website presentation (i.e., GUI 160).

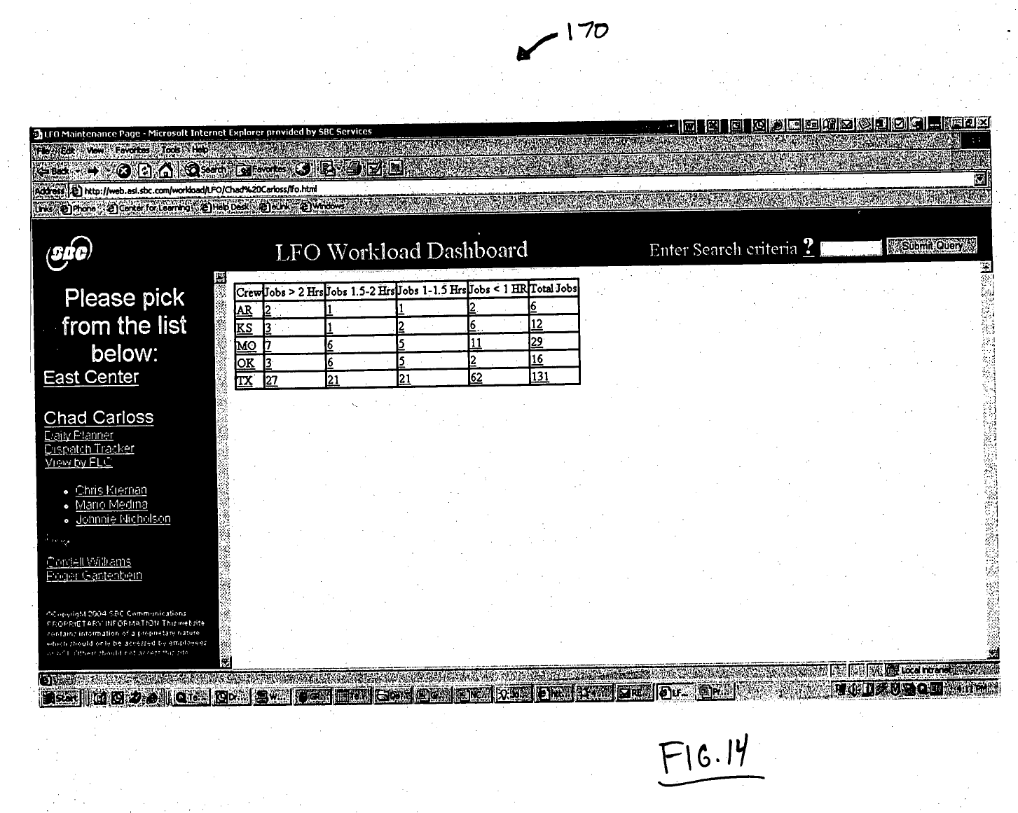

Referring now to FIG. 14, with continual reference to FIG. 12, a GUI 170 generated by dashboard application 12 for displaying to a user 28 an LFO dispatch tracker trouble ticket report is shown. GUI 170 represents a dispatch tracker view showing the length of time outside technicians have been dispatched on certain jobs. Dashboard application 12 has the ability to use GUI 170 to send reminder or escalation pages or e-mails to technician or management service provider users based on preset escalation matrices.

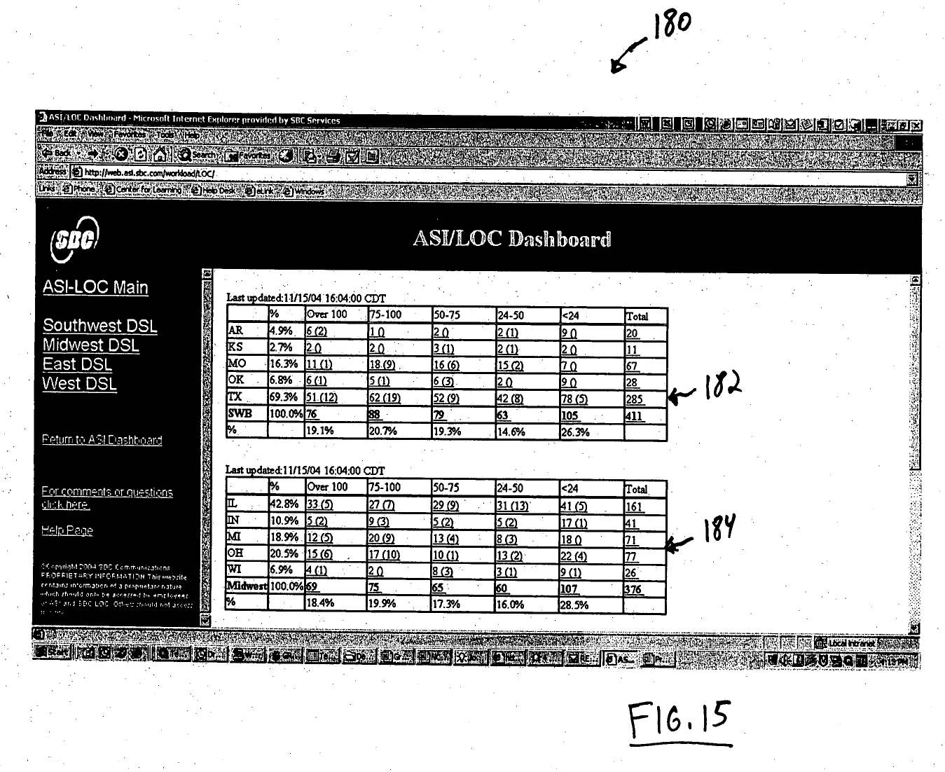

Referring now to FIG. 15, a GUI 180 generated by dashboard application 12 for displaying to a user 28 an ASI/LOC trouble ticket report is shown. GUI 180 represents an ASI/LOC view which interlinks separate departmental units (i.e., interlinks the ASI and the LOC). GUI 180 shows pending load from the internal customer perspective in which the ASI is a customer to the LOC (i.e., the phone company Local Operations Center). Again GUI 180 includes tables 182 and 184 which have state and regions arranged vertically and the duration of trouble tickets arranged horizontally.

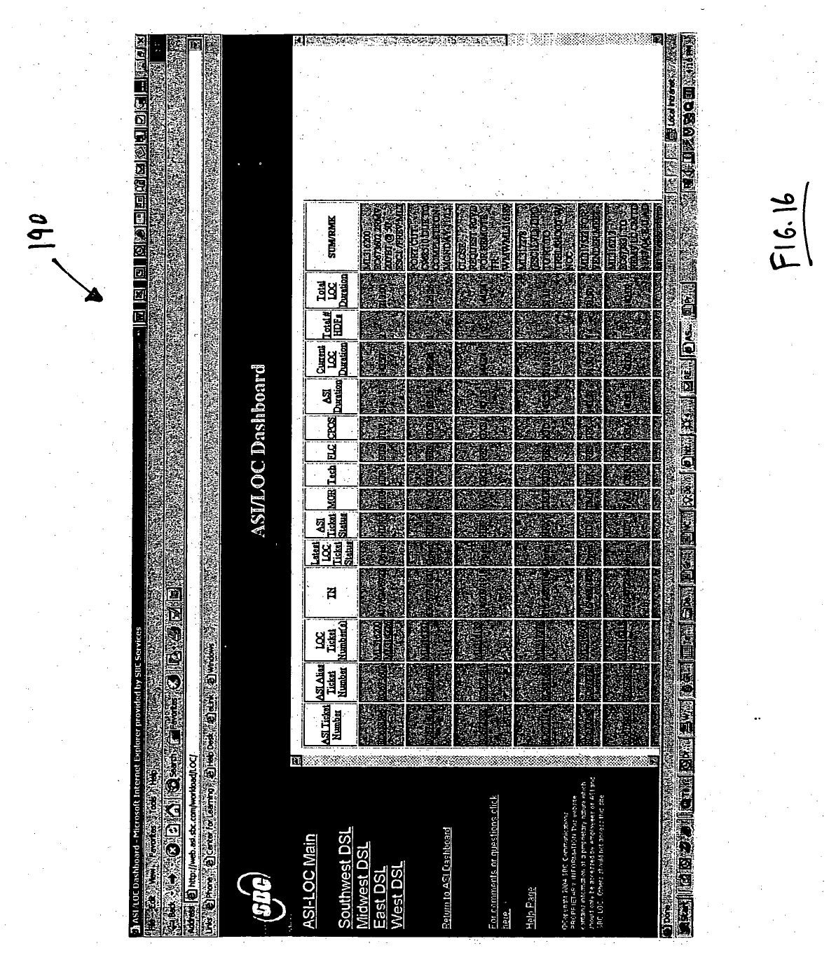

Referring now to FIG. 16, with continual reference to FIG. 15, a GUI 190 generated by dashboard application 12 for displaying to a user 28 a ticket view of interlinking ASI ticket systems with telephone company ticket systems is shown.

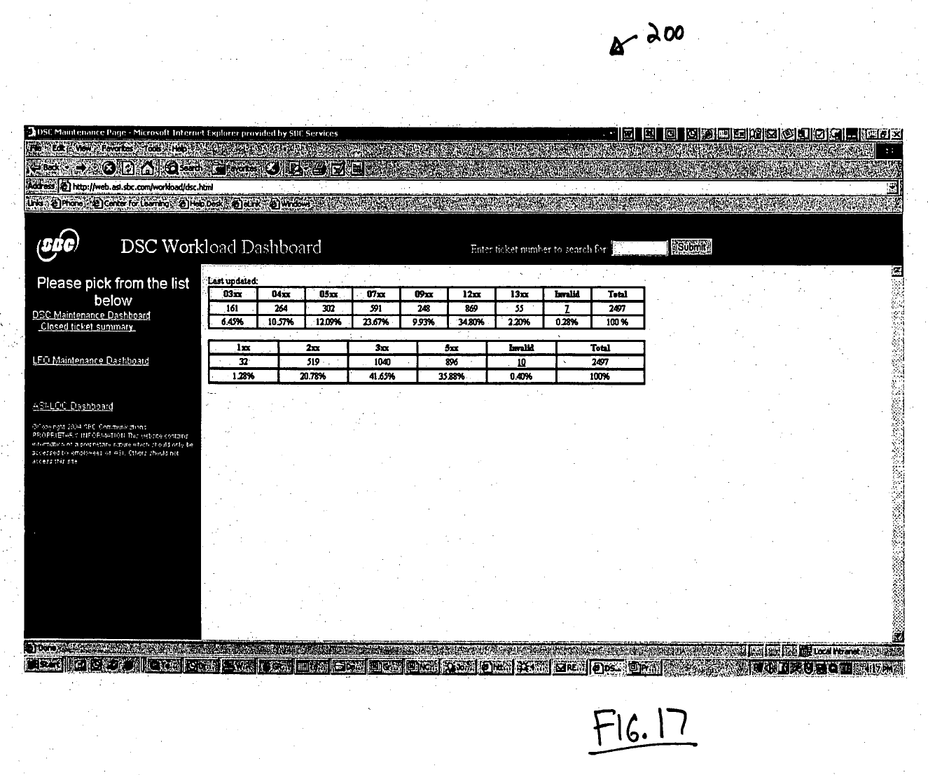

Referring now to FIG. 17, a GUI 200 generated by dashboard application 12 for displaying to a user 28 a closed trouble ticket summary report is shown. GUI 200 shows a summary of trouble tickets based on disposition and cause codes and points out trouble tickets that were closed out due to invalid codes.

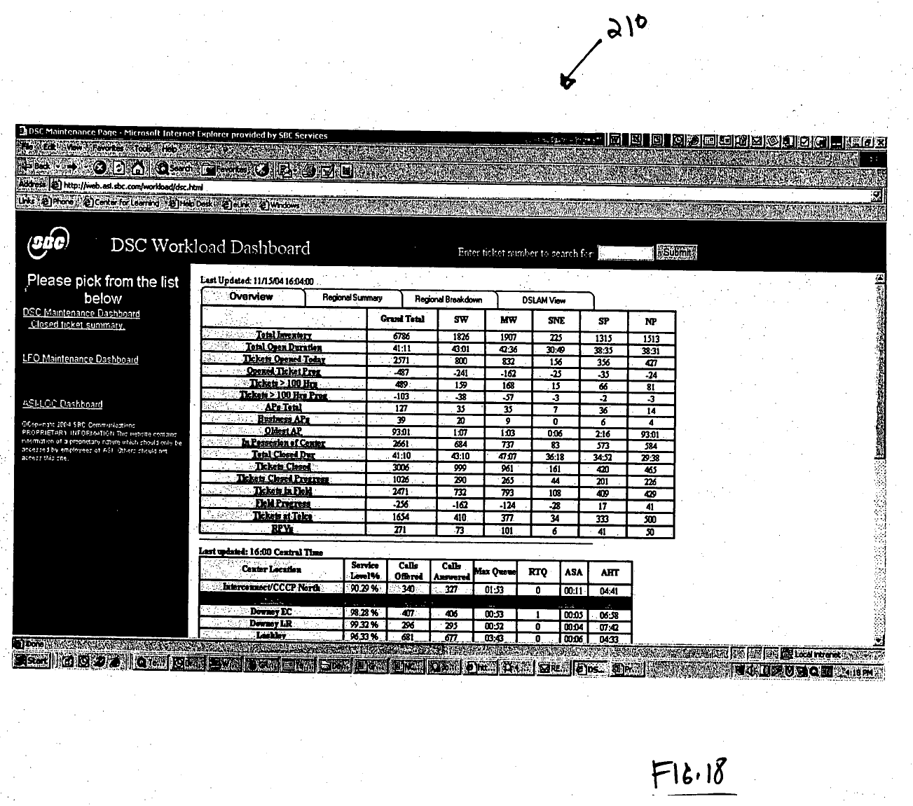

Referring now to FIG. 18, a GUI 210 generated by dashboard application 12 for displaying to a user 28 an overall trouble ticket summary report is shown. GUI 210 shows an overall business view summary of all independent reports and screens.

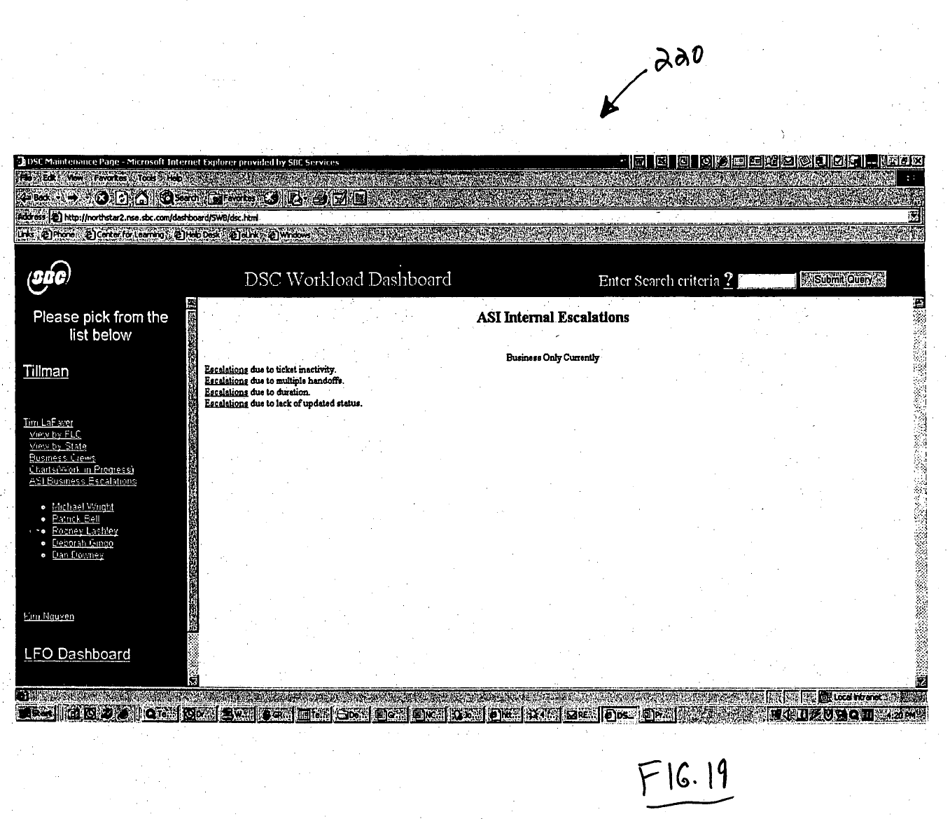

Referring now to FIG. 19, a GUI 220 generated by dashboard application 12 for displaying to a user 28 an internal escalation trouble ticket report is shown. GUI 220 represents an internal escalation page and is used to point out trouble tickets that are not meeting preset center operating thresholds. Dashboard application 12 is operable to send appropriate escalation e-mails to service provider management.

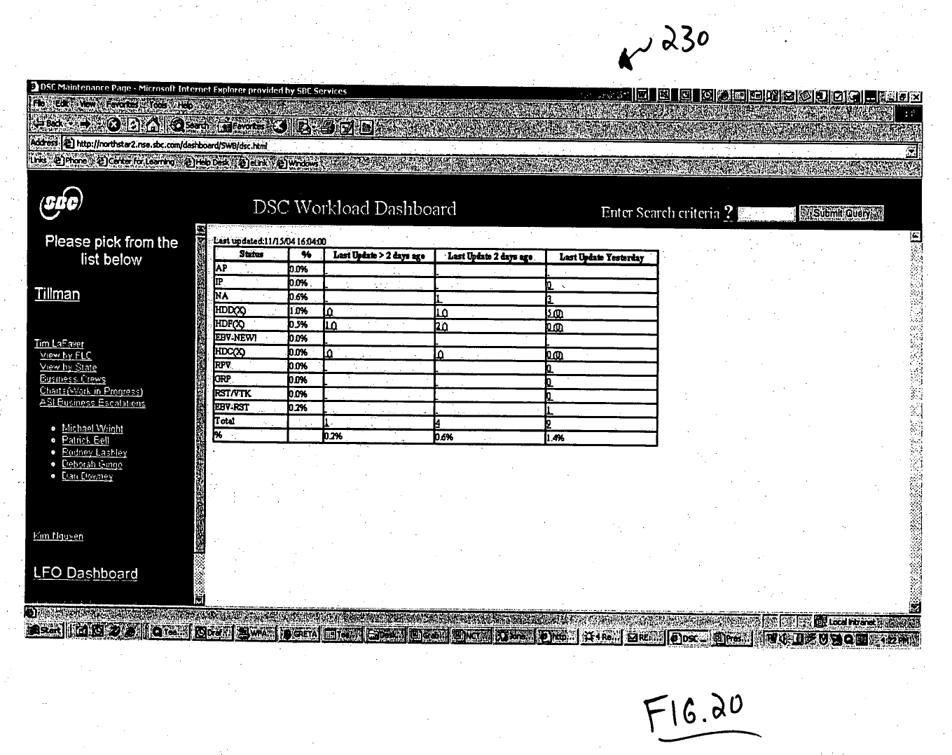

Referring now to FIG. 20, with continual reference to FIG. 19, a GUI 230 generated by dashboard application 12 to alert service provider management of trouble ticket escalation events is shown. The information regarding escalations based on trouble tickets is generally not reviewed by service provider technicians. Each time a threshold is met, the escalation in GUI 230 is moved to the next level along with a notification e-mail with the trouble tickets numbers to the appropriate service provider management.

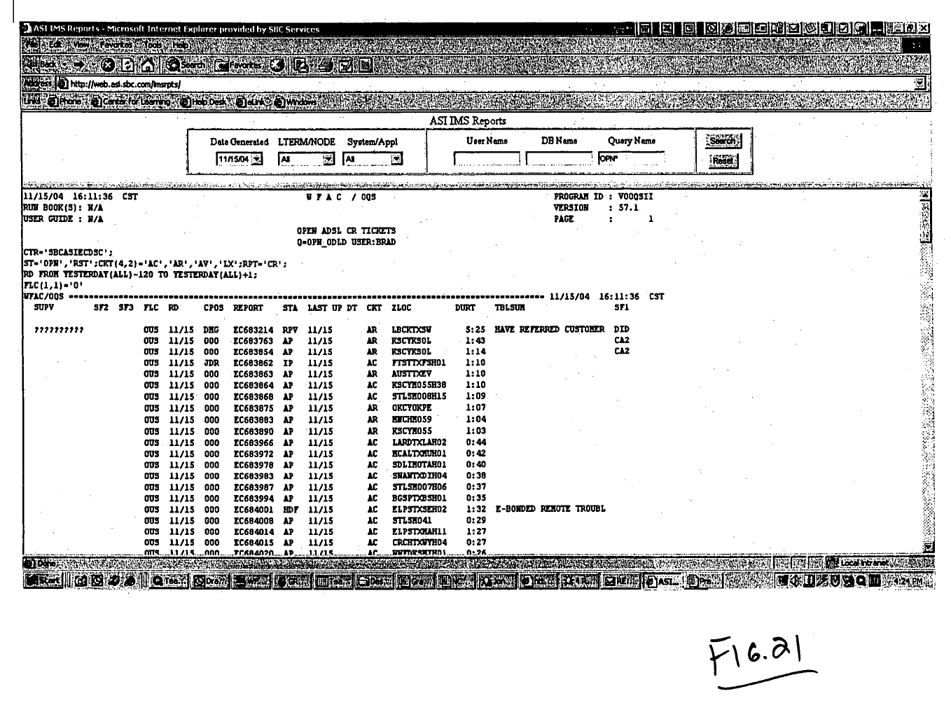

Referring now to FIG. 21, an example of an OQS report from OQS servers 20, 22 is shown. Again, dashboard application 12 receives such OQS reports on a periodic basis from OQS servers 20, 22. The OQS reports represent information regarding trouble tickets stored in WFA systems 14, 16. As shown in FIG. 21, OQS reports are in plain text and can only be pulled for single criteria and are total queries (shows total trouble tickets for example; there is no options of drilling down, jumping/navigating through trouble ticket screens; etc.). As described, dashboard application 12 offers e-business solutions to what service provider management had to organize and retrieve through the use of spreadsheets, and by jumping back and forth between several screens and systems.

As described, WFA systems are not GUI systems. In order to navigate between screens of WFA systems, typed in commands are required and there is no point-and-click ability. WFA systems further require client-based software installation and are high maintenance, not efficient, and hard to modify and customize.

In contrast, dashboard application 12 of trouble ticket monitoring system 10 provides an Internet-enabled Web-based GUI interface to the WFA systems. As such, dashboard application 12 provides Web-based navigation between screens with point and click ability. The logic is on the server side and all options are accessible through a Web-browser such as Internet Explorer. As a result, trouble ticket monitoring system 10 is very customizable—only the server needs to be updated as new additions and modifications are required. Current solutions (such as WFA systems described in the preceding paragraph) require users to have client based software installed on their personal computers which requires a high level of maintenance to operate.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A system for generating and monitoring trouble tickets, the system comprising:
a Work and Force Administration (WFA) system for storing trouble tickets;
a WFA Online Query System (OQS) server for generating information indicative of the trouble tickets stored in the WFA system at a given time; and
a dashboard application having an Internet-enabled and Web-based graphical user interface (GUI) to the WFA system, the dashboard application receiving the information from the WFA OQS server, the dashboard application processing the information from the WFA OQS server to generate a GUI trouble ticket report of the trouble tickets stored in the WFA system for display to a user, wherein the dashboard application adds hyperlinks to the GUI trouble ticket report to enable the user to select the hyperlinks to cause the dashboard application to generate GUI drilled-down trouble ticket reports for display to the user.

2. The system of claim 1 wherein:
a GUI drilled-down trouble ticket report is a GUI trouble ticket report which lists trouble tickets associated with a hyperlink.

3. The system of claim 2 wherein:
the dashboard application generates a GUI for display to the user for the user to use in order to input search criteria, wherein the dashboard application processes the information from the WFA OQS server based on the search criteria to generate the GUI of the trouble ticket report for display to the user, wherein the GUI trouble ticket report lists trouble tickets which satisfy the search criteria.

4. The system of claim 3 wherein:
the dashboard application adds hyperlinks to the GUI trouble ticket report which lists trouble tickets satisfying the search criteria to enable the user to select the hyperlinks to cause the dashboard application to generate other GUI drilled-down trouble ticket reports for display to the user.

5. The system of claim 4 wherein:
the other GUI drilled-down trouble ticket reports are GUI trouble ticket reports listing trouble tickets which satisfy the search criteria and which are associated with selected hyperlinks.

6. The system of claim 1 wherein:
the WFA system includes a Work and Force Administration Control (WFAC) system and a Work and Force Administration Dispatch Out (WFADO) system, wherein the WFA server includes a WFAC OQS server and a WFADO OQS server, wherein the WFAC OQS server generates information indicative of the trouble tickets stored in the WFAC system at a given time and the WFADO OQS server generates information indicative of the trouble tickets stored in the WFADO system at a given time;
wherein the GUI of the dashboard application interfaces to the WFAC and WFADO systems, wherein the dashboard application receives the information from the WFAC and WFADO OQS servers and processes this information to generate a combined GUI trouble ticket report of the trouble tickets stored in the WFAC and WFADO systems for display to the user, wherein the dashboard application adds hyperlinks to the combined GUI trouble ticket report to enable the user to select the hyperlinks to cause the dashboard application to generate combined GUI drilled-down trouble ticket reports for display to the user.

7. The system of claim 6 wherein:
a combined GUI drilled-down trouble ticket report is a combined GUI trouble ticket report listing trouble tickets stored in both the WFAC and WFADO systems and which are associated with a hyperlink.

8. The system of claim 7 wherein:
the dashboard application generates a GUI for display to the user for the user to use in order to input search criteria, wherein the dashboard application processes the information from the WFAC and WFADO OQS servers based on the search criteria to generate the combined GUI trouble ticket report for display to the user, wherein the combined GUI trouble ticket report lists trouble tickets which are stored in both the WFAC and WFADO systems and which satisfy the search criteria.

9. The system of claim 8 wherein:
the dashboard application adds hyperlinks to the combined GUI trouble ticket report listing trouble tickets which are stored in both the WFAC and WFADO systems and which satisfy the search criteria to enable the user to select the hyperlinks to cause the dashboard application to generate other combined GUI drilled-down trouble ticket reports for display to the user.

10. The system of claim 9 wherein:
the other combined GUI drilled-down trouble ticket reports are combined GUI trouble ticket reports listing trouble tickets which are stored in both the WFAC and WFADO systems, which satisfy the search criteria, and which are associated with selected hyperlinks.

11. The system of claim 1 wherein:
the dashboard application generates a GUI for the user to use in order to update a trouble ticket stored in the WFA system, wherein the dashboard application transfers updated trouble ticket information to the WFA system for the WFA system to use in order to update the trouble ticket.

12. The system of claim 1 wherein:
the dashboard application generates a GUI for the user to use in order to add a trouble ticket for storage in the WFA system, wherein the dashboard application transfers added trouble ticket information to the WFA system for the WFA system to use in order to store a new trouble ticket.

13. The system of claim 1 wherein:
the Internet-enabled and Web-based GUI interfaces to embedded testing systems while interfacing to the WFA system.

14. The system of claim 1 wherein:
the dashboard application periodically receives the information from the WFA OQS server and processes this information to update the GUI trouble ticket report of the trouble tickets stored in the WFA system for display to the user.

15. The system of claim 1 wherein:
the dashboard application compares the information from the WFA OQS server with preset escalation criteria, wherein the dashboard application generates a GUI escalation trouble ticket report of the trouble tickets stored in the WFA system which satisfy the preset escalation criteria for display to a user.

16. The system of claim 15 wherein:
the dashboard application adds escalation hyperlinks to the GUI escalation trouble ticket report to enable the user to select the escalation hyperlinks to cause the dashboard application to generate GUI escalation drilled-down trouble ticket reports for display to the user.

17. The system of claim 16 wherein:
a GUI escalation drilled-down trouble ticket report is a GUI escalation trouble ticket report which lists trouble tickets associated with an escalation hyperlink.

18. The system of claim 15 wherein:
the dashboard application generates a GUI for the user to use in order to define the preset escalation criteria.

19. The system of claim 15 wherein:
the dashboard application locally stores information regarding the GUI escalation trouble ticket report for later use by the user.

20. The system of claim 1 wherein:
the dashboard application runs on a personal computer connected to the Internet.
